(19) United States
(12) Patent Application Publication
(10) Pub. No.: US 2026/0016800 A1
(43) Pub. Date: Jan. 15, 2026

(54) LEARNING MODEL CREATION METHOD, INFORMATION PROCESSING METHOD, COMPUTER PROGRAM, AND INFORMATION PROCESSING APPARATUS

(71) Applicant: Tokyo Electron Limited, Tokyo (JP)

(72) Inventors: Masaki KITSUNEZUKA, Sapporo City (JP); Jun SHINAGAWA, Fremont, CA (US); Chungjong LEE, Tokyo (JP)

(73) Assignee: Tokyo Electron Limited, Tokyo (JP)

(21) Appl. No.: 19/331,088

(22) Filed: Sep. 17, 2025

Related U.S. Application Data
(63) Continuation of application No. PCT/JP2023/011489, filed on Mar. 23, 2023.

(51) Int. Cl. G05B 13/04; G05B 13/02

(52) U.S. Cl. CPC G05B 13/048; G05B 13/0265

(57) ABSTRACT

A method includes acquiring structure parameters and reflected light spectra before and after a change in a state of a substrate caused by substrate processing, calculating a structure parameter and a reflected light spectrum in a change period based on the acquired structure parameters and reflected light spectra before and after changing the state of the substrate, creating a learning model that receives a reflected light spectrum as an input and outputs a predicted value of a structure parameter, by performing machine learning using a training data set that includes the structure parameters and the reflected light spectra before and after changing the state of the substrate and the calculated structure parameter and reflected light spectrum and using the predicted value of the structure parameter to automatically adjust an operational parameter of a substrate processing.

### CROSS-REFERENCE TO RELATED APPLICATION

This application is a bypass continuation application of international application No. PCT/JP2023/011489 having an international filing date of Mar. 23, 2023 and designating the United States, the entire contents of which are incorporated herein by reference.

### TECHNICAL FIELD

The present disclosure relates to a learning model creation method, an information processing method, a non-transitory computer readable medium (e.g., computer program), and an information processing apparatus.

### BACKGROUND

PTL 1 proposes an etching monitoring apparatus that includes a continuous wave broadband light source, an illumination system that modulates an incident light beam from the light source by a shutter, and a collection system that collects reflected light reflected from an illumination region on a substrate. The etching monitoring apparatus determines a feature value based on processed light obtained by processing the reflected light beam to prevent background light, and controls etching processing based on the determined feature value.

### CITATION LIST

### Patent Documents

PTL 1: JP2020-517093A

### SUMMARY

The present disclosure provides a learning model creation method, an information processing method, a non-transitory computer readable medium, and an information processing apparatus for achieving prediction of a structure parameter based on a reflected light spectrum acquired during substrate processing.

The learning model creation method according to an embodiment includes: acquiring structure parameters and reflected light spectra before and after a change in a state of a substrate caused by substrate processing for changing the state of the substrate; calculating a structure parameter and a reflected light spectrum at a predetermined timing in a change period based on the acquired structure parameters and reflected light spectra before and after the change; and creating a learning model that receives a reflected light spectrum as an input and outputs a predicted value of a structure parameter, by performing machine learning using a training data set that includes the structure parameters and the reflected light spectra before and after the change and the calculated structure parameter and reflected light spectrum at the predetermined timing, which are executed by an information processing apparatus.

According to the present disclosure, it is expected to achieve prediction of a structure parameter based on a reflected light spectrum acquired during substrate processing.

### BRIEF DESCRIPTION OF DRAWINGS

FIG. 1 is a schematic diagram illustrating an overview of an information processing system according to the present embodiment;

FIG. 2 is a schematic diagram illustrating a schematic configuration of a substrate processing apparatus according to the present embodiment;

FIG. 3 is a schematic diagram illustrating an example of structure parameters measured by a structure parameter measurement device;

FIG. 4 is a schematic diagram illustrating an example of reflected light spectra measured by a spectral reflectometer of the substrate processing apparatus;

FIG. 5 is a block diagram illustrating an example of a hardware configuration of an information processing apparatus according to the present embodiment;

FIG. 6 is a block diagram illustrating an example of a functional configuration of the information processing apparatus according to the present embodiment;

FIG. 7 is a schematic diagram illustrating a specific example of intermediate spectrum synthesis processing and intermediate spectrum selection processing;

FIG. 8 is a schematic diagram illustrating a specific example of learning model creation processing;

FIG. 9 is a schematic diagram illustrating a specific example of prediction processing using a learning model 5;

FIG. 10 is a flowchart illustrating an example of a processing procedure executed by the information processing apparatus according to the present embodiment in a learning phase;

FIG. 11 is a flowchart illustrating an example of a processing procedure executed by the information processing apparatus according to the present embodiment in a prediction phase;

FIG. 12 is a block diagram illustrating an example of a functional configuration of an information processing apparatus according to Embodiment 2;

FIG. 13 is a flowchart illustrating an example of a processing procedure executed by the information processing apparatus according to Embodiment 2 in a learning phase; and

FIG. 14 is a flowchart illustrating an example of a processing procedure executed by the information processing apparatus according to Embodiment 2 in a prediction phase.

### DETAILED DESCRIPTION

Hereinafter, a specific example of an information processing system according to the embodiment of the present disclosure will be described with reference to the drawings. The present disclosure is not limited to these examples, and is defined by the claims, and is intended to include all modifications within the meaning and scope equivalent to the claims.

### Embodiment 1

### <System Overview>

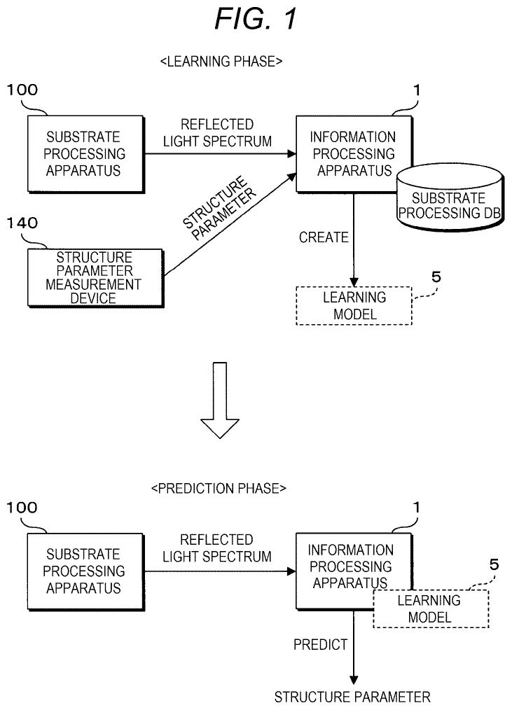

FIG. 1 is a schematic diagram illustrating an overview of an information processing system according to the present embodiment. The information processing system according to the present embodiment includes a substrate processing apparatus 100 and an information processing apparatus 1. The substrate processing apparatus 100 is an apparatus that executes various kinds of substrate processing such as chemical vapor deposition (CVD), sputtering, or etching on a substrate such as a semiconductor wafer. The information processing apparatus 1 is an apparatus that performs monitoring, controlling, or the like on an operation of the substrate processing apparatus 100. The information processing apparatus 1 can cause the substrate processing apparatus 100 to execute various kinds of substrate processing by acquiring information measured by, for example, a measurement device, a sensor, or the like provided in the substrate processing apparatus 100, and controlling an operation of the substrate processing apparatus 100 based on the acquired information.

In the information processing system according to the present embodiment, the information processing apparatus 1 monitors and controls the substrate processing apparatus 100 using a learning model 5 that is trained by machine learning in advance, that is, so-called artificial intelligence (AI). Therefore, processing executed by the information processing system according to the present embodiment is roughly divided into two phases of a learning phase in which information for machine learning is collected to create the learning model 5, and a prediction phase in which monitoring, control, and the like of the substrate processing apparatus 100 are performed based on prediction using the created learning model 5. A configuration of the information processing system in the learning phase for creating the learning model 5 is schematically illustrated in an upper side of FIG. 1, and a configuration of the information processing system in the prediction phase using the learning model 5 is schematically illustrated in a lower side of FIG. 1.

In the learning phase for creating the learning model 5, the information processing system according to the present embodiment uses a structure parameter measurement device 140. The structure parameter measurement device 140 is a device that measures a structure parameter of a substrate to be processed in the substrate processing apparatus 100. The structure parameter measurement device 140 measures a structure parameter of the substrate before substrate processing is executed in the substrate processing apparatus 100, and a structure parameter of the substrate after the substrate processing is executed in the substrate processing apparatus 100. The structure parameters of the substrate measured by the structure parameter measurement device 140 are index values that quantify a state of the substrate, and may include, for example, an etching depth and an etching film thickness.

In the information processing system according to the present embodiment, the substrate processing apparatus 100 causes a substrate to be processed to be irradiated with light from a light source, and measures a reflected light spectrum obtained by splitting reflected light. The substrate processing apparatus 100 can measure the reflected light spectrum at any timing during the substrate processing, and measures reflected light spectra before the start of the substrate processing and after the end of the substrate processing, and continuously repeats the measurement of the reflected light spectra in a period in which the substrate processing is executed.

The information processing apparatus 1 acquires the reflected light spectra repeatedly measured by the substrate processing apparatus 100, acquires the structure parameters of the substrate measured by the structure parameter measurement device 140 before and after the substrate processing, and stores and accumulates these pieces of information in a substrate processing database (DB) in association with, for example, information such as an ID attached to the substrate and the date and time when the substrate processing was executed.

In the field of substrate manufacturing, a substrate monitoring technique was known in which a state of a substrate is monitored by measuring a reflected light spectrum using, for example, a spectral reflectometer during execution of substrate processing. According to this substrate monitoring technique, for example, a timing for ending the substrate processing can be determined based on the reflected light spectrum by learning in advance a reflected light spectrum that indicates a state of the substrate when the substrate processing is completed. On the other hand, for example, when it is possible to predict not only the state of the substrate when the substrate processing is completed, but also a state of the substrate at any timing from the start to the end of the substrate processing, it is expected to control the substrate processing in real time according to a state of the substrate. However, the state of the substrate does not necessarily change at a uniform rate, and in order to predict the state of the substrate at any timing, it is necessary to learn in advance a relationship between the reflected light spectrum and the state of the substrate at each timing.

In order to perform such learning, for example, it is necessary to stop the substrate processing at various timings, and take out the substrate being processed from the substrate processing apparatus 100. Further, it is necessary to measure a structure parameter of the taken-out substrate by the structure parameter measurement device 140. Therefore, in order to create a learning model for predicting a state of the substrate at any timing, it is difficult to collect a sufficient amount of training data sets, and thus it is difficult to obtain a learning model with high prediction accuracy in the related art.

In the information processing system according to the present embodiment, the information processing apparatus 1 collects reflected light spectra of a substrate continuously measured by the substrate processing apparatus 100 during substrate processing and structure parameters measured by the structure parameter measurement device 140 before and after the substrate processing, and calculates a structure parameter at any timing of the substrate processing based on the collected information. The information processing apparatus 1 creates a training data set in which a reflected light spectrum and a structure parameter at any time of the substrate processing are associated with each other. The information processing apparatus 1 uses the created training data set to execute machine learning processing, accepts a reflected light spectrum at any timing as an input, and creates the learning model 5 for predicting a structure parameter of the substrate to be processed.

The information processing system may not use the structure parameter measurement device 140 in the prediction phase using the created learning model 5 (Alternatively, the structure parameter measurement device 140 may be used). The information processing apparatus 1 acquires the reflected light spectra continuously measured by the substrate processing apparatus 100, inputs the acquired reflected light spectra into the trained learning model 5, and acquires a predicted value for a structure parameter, which is output by the learning model 5. Based on the structure parameter predicted by the learning model 5, the information processing apparatus 1 can perform operation control such as changing a processing condition (recipe) of the substrate processing apparatus 100 or stopping the processing caused by an abnormality. That is, the prediction enables real-time control of a substrate processing apparatus to adjust processing parameters, such as stopping or modifying etching conditions, thereby improving precision in semiconductor manufacturing by preventing over-etching, reducing defects, and enhancing yield without interrupting the process. This real-time prediction and control integrate the learning model into a practical application for semiconductor substrate processing, where the predicted structure parameter is used to automatically adjust operational parameters of the substrate processing apparatus 100, such as gas flow rates, plasma power levels, or processing duration, to achieve precise etching depths or mask dimensions. For example, if the predicted etching depth exceeds a predefined threshold, the information processing apparatus 1 outputs a control signal to the control device 130 of the substrate processing apparatus 100 to reduce plasma intensity or halt the process, thereby preventing defects like over-etching or under-etching, which improves manufacturing yield and reduces material waste by ensuring substrates meet specifications without post-processing corrections.

In the present embodiment, the information processing apparatus 1 that executes processing for creating the learning model 5 through machine learning in the learning phase and the information processing apparatus 1 that executes processing for predicting a structure parameter at any timing of the substrate processing by using the trained learning model 5 in the prediction phase is described as the same apparatus. Alternatively, the present disclosure is not limited thereto. The information processing apparatus 1 that executes processing in the learning phase may be different from the information processing apparatus 1 that executes processing in the prediction phase. For example, the information processing apparatus 1 in the learning phase may be a server device or the like having a high calculation capability, and the information processing apparatus 1 in the prediction phase may be a control device disposed inside or in the vicinity of the substrate processing apparatus 100.

The substrate processing apparatus 100 and the structure parameter measurement device 140 from which the information processing apparatus 1 collects information such as a reflected light spectrum and a structure parameter in the learning phase may not be one device, and the information processing apparatus 1 may collect information from a plurality of the substrate processing apparatuses 100 and the structure parameter measurement devices 140. Further, the information processing apparatus 1 that predicts a structure parameter in the prediction phase may be a plurality of the information processing apparatuses 1. For example, the learning models 5 created by the information processing apparatus 1 may be distributed to control devices of the plurality of substrate processing apparatuses 100, and the plurality of control devices may perform control for the respective substrate processing apparatuses 100 using the learning models 5.

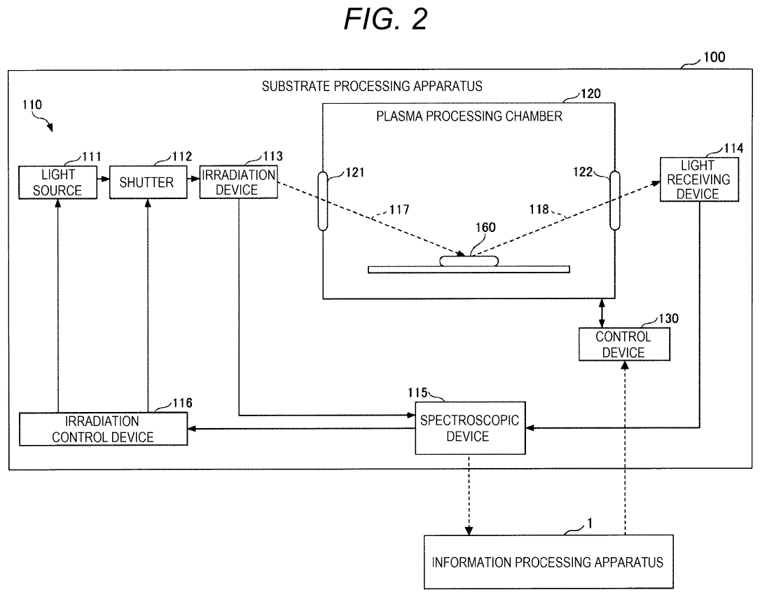

FIG. 2 is a schematic diagram illustrating a schematic configuration of the substrate processing apparatus 100 according to the present embodiment. The substrate processing apparatus 100 according to the present embodiment includes a spectral reflectometer 110, a plasma processing chamber 120, a control device 130, and the like.

The spectral reflectometer 110 is, for example, a device that irradiates a substrate 160 being processed with light and measures reflected light from the substrate 160 during the substrate 160 is subject to plasma etching processing in the plasma processing chamber 120. The spectral reflectometer 110 includes a light source 111, a shutter 112, an irradiation device 113, a light receiving device 114, a spectroscopic device 115, an irradiation control device 116, and the like. The light source 111 emits light for forming an incident light beam 117. The shutter 112 modulates light emitted from the light source 111. The irradiation device 113 irradiate the substrate 160 with the light modulated by the shutter 112 through an optical window 121 to form the incident light beam 117. The light emitted onto the substrate 160 is reflected by the substrate 160 to form a reflected light beam 118. The irradiation device 113 transmits a part of the light modulated by the shutter 112 to the spectroscopic device 115.

The light receiving device 114 receives the formed reflected light beam 118 through the optical window 122. The reflected light beam 118 received by the light receiving device 114 is transmitted to the spectroscopic device 115. The spectroscopic device 115 spectroscopes the reflected light beam 118 and measures a reflected light spectrum (a light intensity per wavelength). The spectroscopic device 115 outputs the measured reflected light spectrum to the information processing apparatus 1. The spectroscopic device 115 instructs the irradiation control device 116 to increase or decrease a light intensity so that an intensity of light transmitted from the irradiation device 113 is a predetermined intensity. The irradiation control device 116 controls operations of the light source 111 and the shutter 112. The irradiation control device 116 controls an intensity of the light emitted from the light source 111 based on an instruction from the spectroscopic device 115.

In the plasma processing chamber 120, substrate processing such as plasma etching is executed on the substrate 160 under a predetermined processing condition (recipe). The control device 130 controls various operation terminals in the plasma processing chamber 120 and controls the substrate processing executed in the plasma processing chamber 120 based on a preset processing condition (recipe) and an instruction given from the information processing apparatus 1.

### <Structure Parameter And Reflected Light Spectrum>

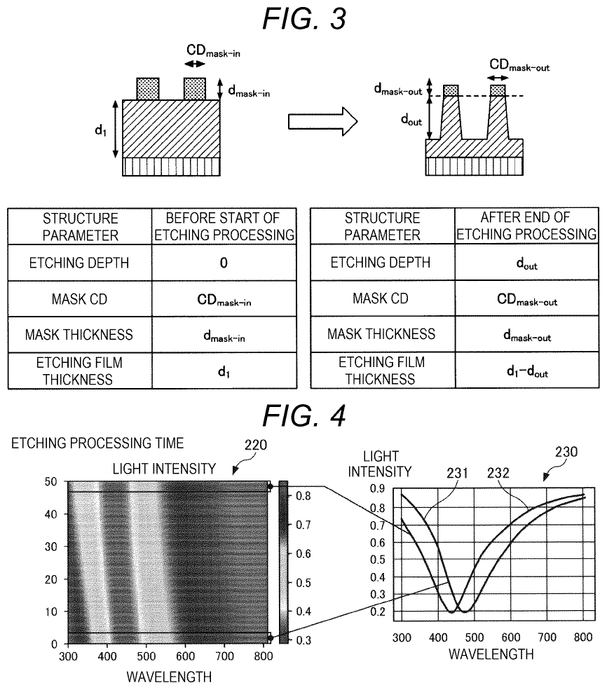

FIG. 3 is a schematic diagram illustrating an example of structure parameters measured by the structure parameter measurement device 140. An example of a cross-sectional shape and structure parameters of the substrate 160 before the start of the substrate processing are illustrated on a left side of FIG. 3, and an example of a cross-sectional shape and structure parameters of the substrate 160 after the end of the plasma etching processing are illustrated on a right side of FIG. 3. In the present embodiment, the structure parameter measurement device 140 measures structure parameters such as an etching depth of the substrate, a mask critical dimension (CD), a mask thickness, and an etching film thickness.

In the illustrated example, the etching depth, the mask CD, the mask thickness, and the etching film thickness measured by the structure parameter measurement device 140 before the start of the substrate processing are as follows.
Etching depth=0,
Mask CD=CDmask-in,
Mask thickness=dmask-in, and
Etching film thickness=d1

Similarly, the etching depth, the mask CD, the mask thickness, and the etching film thickness measured by the structure parameter measurement device 140 after the end of the substrate processing are as follows.
Etching depth=dout,
Mask CD=CDmask-out,
Mask thickness=dmask-out, and
Etching film thickness=d1-dout

FIG. 4 is a schematic diagram illustrating an example of reflected light spectra measured by the spectral reflectometer 110 of the substrate processing apparatus 100. The reflected light spectra illustrated in this example are measured by the spectral reflectometer 110 and output from the spectroscopic device 115 in a measurement period from before the start of the substrate processing to after the end of the substrate processing, and are acquired by the information processing apparatus 1. A graph 220 illustrated on a left side of FIG. 4 is a graph in which a horizontal axis represents a wavelength and a vertical axis represents a substrate processing time (etching processing time), and a color difference in the graph 220 represents a light intensity difference for each wavelength in each time. A graph 230 illustrated on a right side of FIG. 4 is a graph in which a horizontal axis represents a wavelength and a vertical axis represents a light intensity. The graph 230 illustrates a continuous curve of a reflected light spectrum 231 before the start of the substrate processing and a continuous curve of a reflected light spectrum 232 after the end of the substrate processing among the reflected light spectra illustrated in the graph 220.

As illustrated in FIGS. 3 and 4, the information processing apparatus 1 according to the present embodiment can collect
a structure parameter and a reflected light spectrum of the substrate 160 before the start of the substrate processing, and
a structure parameter and a reflected light spectrum of the substrate 160 after the end of the substrate processing,
as a training data set.

Meanwhile, it is possible to collect reflected light spectra in a measurement period from before the start of the substrate processing to after the end of the substrate processing. However, it is difficult to collect structure parameters. This is because in order to collect structure parameters at each timing of the measurement period, it is necessary to stop the substrate processing at each timing, take out the substrate 160 from the plasma processing chamber 120, measure structure parameters for the taken-out substrate 160, or the like.

Therefore, the information processing apparatus 1 according to the present embodiment calculates a structure parameter and a reflected light spectrum at any timing in the measurement period by using the structure parameters and the reflected light spectra before the start of the substrate processing and after the end of the substrate processing. Further, the information processing apparatus 1 creates a training data set that includes the structure parameters and the reflected light spectra before the start of the substrate processing, at any timing in the measurement period, and after the end of the substrate processing, and causes the learning model 5 to learn a relationship between a structure parameter and a reflected light spectrum. In this manner, the information processing apparatus 1 can collect a sufficient amount of training data sets for performing the machine learning for the learning model 5, by calculating a structure parameter and a reflected light spectrum at any timing in the measurement period. As a result, the information processing apparatus 1 can accurately predict a structure parameter of the substrate at any timing.

In the learning phase for creating the learning model 5 in the present embodiment, the information processing apparatus 1 creates a training data set based on a structure parameter measured by the structure parameter measurement device 140 and a reflected light spectrum measured by the spectroscopic device 115, and creates the learning model 5 by performing machine learning using the created training data set. In the prediction phase using the learning model 5, the information processing apparatus 1 performs prediction for a structure parameter of the substrate 160 to be monitored using the trained learning model 5, based on the reflected light spectrum measured by the spectroscopic device 115. Based on a structure parameter predicted by the learning model 5, the information processing apparatus 1 notifies the control device 130 of, for example, a stop instruction for stopping the plasma etching processing. Alternatively, the information processing apparatus 1 notifies the control device 130 of a change instruction for changing a recipe, based on a structure parameter predicted by the learning model 5. This integration of the prediction into control of the substrate processing apparatus 100 provides a practical application by enabling automated, real-time adjustments to the manufacturing process. Specifically, the control device 130 receives the predicted structure parameter and modifies hardware operations, such as adjusting radio frequency (RF) power supplied to the plasma processing chamber 120 if the predicted mask CD deviates by more than a target amount, or terminating gas inflow to stop etching when the predicted depth is reached. Such controls are implemented via communication interfaces between the information processing apparatus 1 and the control device 130, using protocols like Ethernet for Control Automation Technology (EtherCAT), ensuring sub-second response times critical for nanoscale precision in semiconductor devices like logic chips or memory cells. This practical application not only improves the technological process of substrate manufacturing but also quantifiably reduces defect rates by integrating the predictive output directly into physical control mechanisms.

### <Apparatus Configuration>

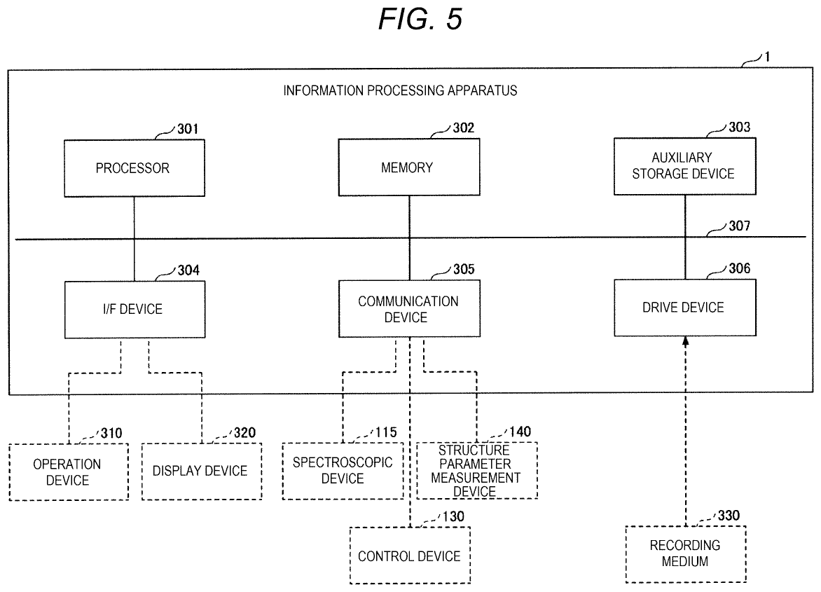

FIG. 5 is a block diagram illustrating an example of a hardware configuration of the information processing apparatus 1 according to the present embodiment. The information processing apparatus 1 according to the present embodiment includes a processor 301, a memory 302, an auxiliary storage device 303, an interface (I/F) device 304, a communication device 305, a drive device 306, and the like. The hardware components of the information processing apparatus 1 are connected to one another through a bus 307.

The processor 301 includes various calculation devices such as a central processing unit (CPU) and a graphics processing unit (GPU). The processor 301 reads various programs (for example, a substrate monitoring program to be described later) from the memory 302 and executes the programs. The memory 302 includes a main storage device such as a read only memory (ROM) and a random access memory (RAM). The processor 301 and the memory 302 form a so-called computer, and the computer implements various functions by executing the various programs read from the memory 302 by the processor 301. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The auxiliary storage device 303 stores various programs and various types of data (for example, training data sets) used when the various programs are executed by the processor 301. The I/F device 304 is a connection device that connects an operation device 310, a display device 320, and the like to the information processing apparatus 1. The communication device 305 is a communication device for communicating with the spectroscopic device 115, the control device 130, the structure parameter measurement device 140, and the like. The drive device 306 is a device for which a recording medium 330 is set. Here, the recording medium 330 includes a medium for optically, electrically, or magnetically recording information, such as a CD-ROM, a flexible disk, and a magneto-optical disk. The recording medium 330 may also include a semiconductor memory or the like that electrically records information, such as a ROM, a flash memory, or the like.

The various programs to be installed in the auxiliary storage device 303 are installed by the drive device 306 reading the various programs recorded in the recording medium 330 when, for example, the distributed recording medium 330 is set in the drive device 306. Alternatively, the various programs to be installed in the auxiliary storage device 303 may be installed by downloading from a network via the communication device 305.

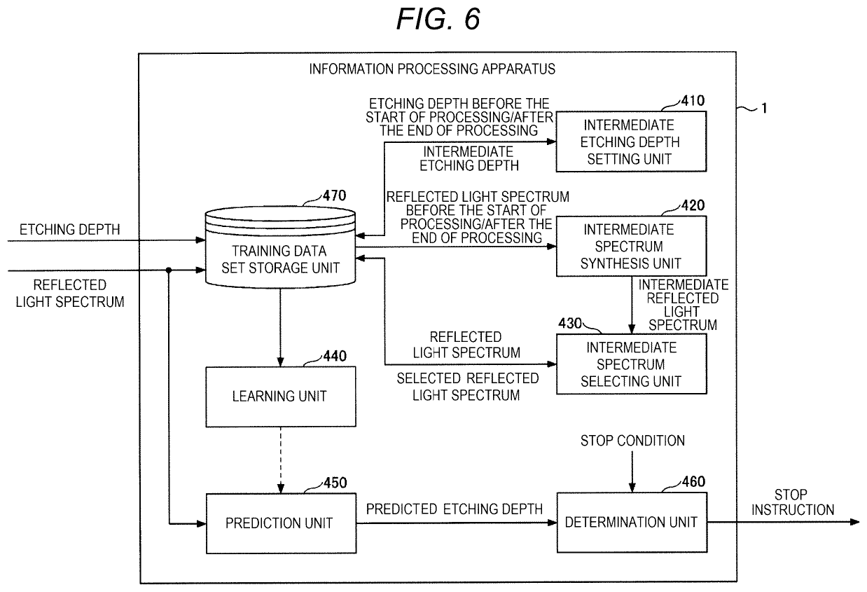

FIG. 6 is a block diagram illustrating a configuration example of the information processing apparatus 1 according to the present embodiment. Hereinafter, a case where the information processing apparatus 1 predicts an etching depth among the structure parameters illustrated in FIG. 3 will be described. As described above, the substrate monitoring program is installed in the information processing apparatus 1, and when the processor 301 executes the program, the information processing apparatus 1 functions as functional units such as an intermediate etching depth setting unit 410, an intermediate spectrum synthesis unit 420, an intermediate spectrum selecting unit 430, and a learning unit 440 in the learning phase.

To operate the above-described functional units in the learning phase, a training data set storage unit 470 stores reflected light spectra (see the graph 220 in FIG. 4) measured by the spectroscopic device 115 in the measurement period from before the start of the plasma etching processing (substrate processing) to after the end of the plasma etching processing. The training data set storage unit 470 stores, as a training data set, etching depths measured by the structure parameter measurement device 140 before the start and after the end of the plasma etching processing, and reflected light spectra measured by the spectroscopic device 115 before the start and after the end of the plasma etching processing (see the curves 231 and 232 in the graph 230 of FIG. 4) in association with each other.

The intermediate etching depth setting unit 410 reads the etching depth before the start of the plasma etching processing and the etching depth after the end of the plasma etching processing, which are stored in the training data set storage unit 470. The intermediate etching depth setting unit 410 calculates an intermediate etching depth between before the start of the plasma etching processing and after the end of the plasma etching processing, that is, an etching depth at an intermediate time point in a period in which the plasma etching processing is executed. For example, when the etching depth before the start of the plasma etching processing is defined as [0] and the etching depth after the end of the plasma etching processing is defined as [dout], the intermediate etching depth setting unit 410 calculates the intermediate etching depth by the following calculation formula. The intermediate etching depth setting unit 410 stores the calculated intermediate etching depth in the training data set as ground truth data for an intermediate reflected light spectrum.

$$Intermediate etching depth = dout / 2$$

The intermediate spectrum synthesis unit 420 is an example of a calculation unit, and reads the reflected light spectrum 231 before the start of the plasma etching processing and the reflected light spectrum 232 after the end of the plasma etching processing, which are stored in the training data set storage unit 470. The intermediate spectrum synthesis unit 420 calculates candidates for an intermediate reflected light spectrum between before the start of the plasma etching processing and after the end of the plasma etching processing, based on the read reflected light spectra 231 and 232.

Specifically, the intermediate spectrum synthesis unit 420 first executes scale conversion processing and translational movement processing on the reflected light spectrum 231 before the start of the plasma etching processing in either one or both of a wavelength axis direction and a light intensity axis direction. Similarly, the intermediate spectrum synthesis unit 420 executes the scale conversion processing and the translational movement processing on the reflected light spectrum 232 after the end of the plasma etching processing in either one or both of the wavelength axis direction and the light intensity axis direction. In this case, the intermediate spectrum synthesis unit 420 calculates a similarity between the two reflected light spectra obtained by the scale conversion processing and the translational movement processing, and executes scale conversion and translational movement in a reverse direction on the two reflected light spectra such that the similarity is maximized. The intermediate spectrum synthesis unit 420 can calculate, for example, a cosine similarity as the similarity between the two reflected light spectra. However, the present disclosure is not limited to this configuration, and the similarity may be calculated by any calculation.

Next, the intermediate spectrum synthesis unit 420 calculates an average value of light intensities for each wavelength of the two reflected light spectra obtained by the scale conversion processing and the translational movement processing. The intermediate spectrum synthesis unit 420 notifies the intermediate spectrum selecting unit 430 of the average value of the reflected light spectra thus obtained as a candidate for the intermediate reflected light spectrum.

The intermediate spectrum selecting unit 430 reads the reflected light spectra (see the graph 220 of FIG. 4) stored in the training data set storage unit 470 in the measurement period from before the start of the plasma etching processing to after the end of the plasma etching processing. The intermediate spectrum selecting unit 430 calculates a correlation or an error between a plurality of the read reflected light spectra in the measurement period and the candidate for the intermediate reflected light spectrum supplied from the intermediate spectrum synthesis unit 420, and selects a reflected light spectrum similar to the candidate for the intermediate reflected light spectrum from the plurality of reflected light spectra in the measurement period. The intermediate spectrum selecting unit 430 stores the selected reflected light spectrum in the training data set as input data for an intermediate etching depth calculated by the intermediate etching depth setting unit 410.

The learning unit 440 uses a training data set updated by the intermediate etching depth setting unit 410 and the intermediate spectrum selecting unit 430 to perform machine learning for the learning model 5. The learning model 5 for which machine learning is performed by the learning unit 440 is supplied to a prediction unit 450.

On the other hand, the information processing apparatus 1 functions as functional units such as the prediction unit 450 and a determination unit 460 in the prediction phase. To operate the above-described functional units of the information processing apparatus 1 in the prediction phase, the learning model 5 that is trained by the learning unit 440 is set to the prediction unit 450.

During the execution of substrate manufacturing processing, the prediction unit 450 acquires reflected light spectra at a predetermined cycle from the spectroscopic device 115 for a substrate to be monitored, and sequentially inputs the acquired reflected light spectra into the trained learning model 5, thereby predicting etching depths corresponding to the reflected light spectra. The prediction unit 450 sequentially inputs the predicted etching depths into the determination unit 460.

The determination unit 460 determines whether to stop the plasma etching processing based on the etching depths input from the prediction unit 450. A stop condition for stopping the plasma etching processing is set in advance in the determination unit 460. The determination unit 460 determines whether the input etching depth satisfies the stop condition. The stop condition may include a determination timing and a determination item. For example, the “entire range of the measurement period” is set for the detection timing, and a “target value of an etching depth” is set for the determination item. When it is determined that the stop condition is satisfied, the determination unit 460 notifies the control device 130 of an instruction to stop the plasma etching processing. Accordingly, the control device 130 can stop the plasma etching processing at an appropriate timing based on an etching depth.

When the information processing apparatus 1 executes processing of creating the learning model 5 and does not execute prediction processing using the learning model 5, the information processing apparatus 1 may not include the prediction unit 450 and the determination unit 460. Similarly, when the information processing apparatus 1 does not execute the processing of creating the learning model 5 and executes the prediction processing using the learning model 5, the information processing apparatus 1 may not include the intermediate etching depth setting unit 410, the intermediate spectrum synthesis unit 420, the intermediate spectrum selecting unit 430, the learning unit 440, and the training data set storage unit 470. Information about the learning model 5 (for example, information on a structure and internal parameters of the learning model 5) created by one information processing apparatus 1 is supplied to another information processing apparatus 1 via communication, a recording medium, or the like. The other information processing apparatus 1 can reproduce the learning model 5 based on the information supplied from the one information processing apparatus 1, and can execute processing such as prediction and control using the learning model 5.

### <Processing in Learning Phase and Prediction Phase>

### (1) Intermediate Spectrum Synthesis Processing and Intermediate Spectrum Selection Processing

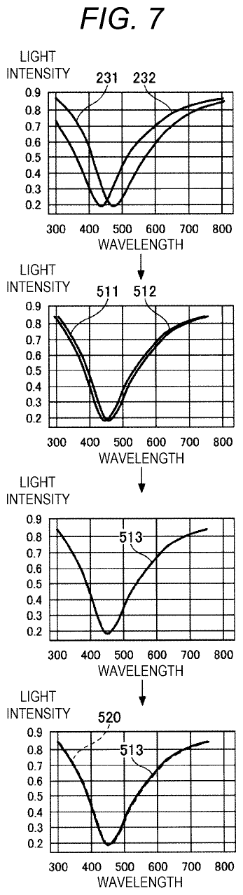

FIG. 7 is a schematic diagram illustrating a specific example of the intermediate spectrum synthesis processing and the intermediate spectrum selection processing. A first graph from the top of FIG. 7 is the same as the graph 230 of FIG. 4, and illustrates the reflected light spectrum 231 before the start of the plasma etching processing and the reflected light spectrum 232 after the end of the plasma etching processing. The intermediate spectrum synthesis unit 420 reads the two reflected light spectra 231 and 232.

The intermediate spectrum synthesis unit 420 executes the scale conversion processing and the translational movement processing on the two read reflected light spectra 231 and 232 based on the following Formula (1). In Formula (1), I represents a light intensity, λ represents a wavelength, the reflected light spectrum 231 before the start of the plasma etching processing is defined as (Iincoming, λincoming), and the reflected light spectrum 232 after the end of the plasma etching processing is defined as (Ipost-etch, λpost-etch). Further, α, β, γ, and δ are coefficients for defining amounts of scale conversion and translational movement. A reflected light spectrum 511 obtained by executing the scale conversion processing and the translational movement processing on the reflected light spectrum 231 before the start of the plasma etching processing is defined as (I′incoming, λ′incoming), and a reflected light spectrum 512 obtained by executing the scale conversion processing and the translational movement processing on the reflected light spectrum 232 after the end of the plasma etching processing is defined as (I′post-etch, λ′post-etch).

$$\begin{matrix}[ Formula 1 ] & \\ {I}_{incoming}^{′} = α ( {I}_{incoming} - β ) & ( 1 )\end{matrix}$$

$${λ}_{incoming}^{′} = γ ( {λ}_{incoming} - δ )$$

$${I}_{post - etch}^{′} = \frac{1}{α} ( {I}_{post - etch} + β )$$

$${λ}_{post - etch}^{′} = \frac{1}{γ} ( {λ}_{post - etch} + δ )$$

The intermediate spectrum synthesis unit 420 changes the coefficients α, β, γ, and σ as appropriate in Formula (1), and searches for a combination of the coefficients α, β, γ, and σ that maximizes the similarity between the two reflected light spectra 511 and 512 obtained based on Formula (1). A second graph from the top of FIG. 7 illustrates a case where the similarity between the two reflected light spectra 511 and 512 obtained through the scale conversion processing and the translational movement processing is maximized.

Next, the intermediate spectrum synthesis unit 420 calculates an average value of the two reflected light spectra 511 and 512 subjected to the scale conversion processing and the translational movement processing so as to maximize the similarity, based on the following Formula (2). The intermediate spectrum synthesis unit 420 supplies the calculated average value to the intermediate spectrum selecting unit 430 as a candidate 513 for the intermediate reflected light spectrum. A third graph from the top of FIG. 7 illustrates the candidate 513 for the intermediate reflected light spectrum.

$$\begin{matrix}[ Formula 2 ] & \\ {\hat{I}}_{half - etch} ( λ ) = \frac{{I}_{incoming}^{′} ( {λ}_{incoming}^{′} ) + {I}_{post - etch}^{′} ( {λ}_{post - etch}^{′} )}{2} & ( 2 )\end{matrix}$$

The intermediate spectrum selecting unit 430 reads, from the training data set storage unit 470, a plurality of reflected light spectra in the measurement period from before the start of the plasma etching processing to after the end of the plasma etching processing. The intermediate spectrum selecting unit 430 calculates a correlation or an error between the plurality of read reflected light spectra in the measurement period and the candidate 513 for the intermediate reflected light spectrum supplied from the intermediate spectrum synthesis unit 420, and selects a reflected light spectrum 520 similar to the candidate 513 from the plurality of reflected light spectra in the measurement period. A fourth graph from the top of FIG. 7 illustrates the candidate 513 for the intermediate reflected light spectrum and the reflected light spectrum 520 similar to the candidate 513. The intermediate spectrum selecting unit 430 stores the selected reflected light spectrum 520 in the training data set storage unit 470 as input data for an intermediate etching depth calculated by the intermediate etching depth setting unit 410.

Although a case where data at an intermediate time point in the plasma etching processing is included in the training data set is described in the present embodiment, the present disclosure is not limited thereto, and data at any timing of the plasma etching processing may be included in the training data set.

A reflected light spectrum at any timing can be obtained by executing the scale conversion processing and the translational movement processing on the reflected light spectrum 231 before the start of the plasma etching processing and the reflected light spectrum 232 after the end of the plasma etching processing based on the following Formula (3). Formula (3) is an extension of Formula (1) to cope with time points other than the intermediate time point. By properly adjusting a newly introduced variable w, the scale conversion processing and the translational movement processing can be executed to calculate a reflected light spectrum candidate at any timing. Formula (3) becomes Formula (1) when the variable w=0, and can calculate an intermediate reflected light spectrum candidate. When the variable w>0, a candidate close to the reflected light spectrum 231 before the start of the plasma etching processing is calculated, and when the variable w<0, a candidate close to the reflected light spectrum 232 after the end of the plasma etching processing is calculated.

$$\begin{matrix}[ Formula 3 ] & \\ {I}_{incoming}^{′} = {α}^{1 - w} ( {I}_{incoming} - ( 1 - w ) β ) & ( 3 )\end{matrix}$$

$${λ}_{incoming}^{′} = {γ}^{1 - w} ( λ - ( 1 - w ) δ )$$

$${I}_{post - etch}^{′} = \frac{1}{{α}^{1 + w}} ( {I}_{post - etch} + ( 1 + w ) β )$$

$${λ}_{post - etch}^{′} = \frac{1}{{γ}^{1 + w}} ( λ + ( 1 + w ) δ )$$

For example, when an etching depth before the start of the plasma etching processing is defined as d0 and an etching depth after the end of the plasma etching processing is defined as d1, an etching depth d at any timing can be calculated based on the following formula.

$$d = ( d 1 - d 0 ) \times ( 1 - w ) / 2$$

A value of the variable w is appropriately set within a range of −1<w<1. The closer the value of w is to 1, the shallower the etching depth d is, and the closer the value of w is to −1, the deeper the etching depth d is.

### (2) Learning Model Creation Processing

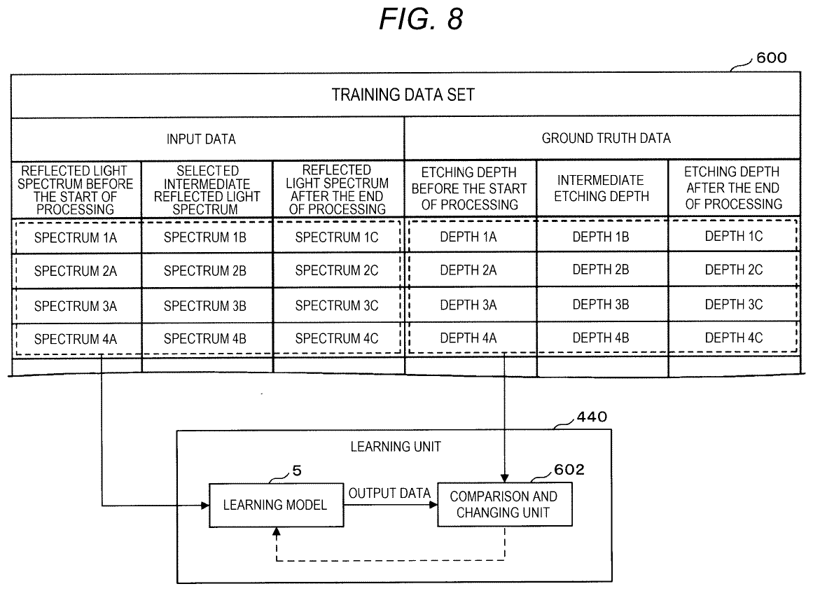

FIG. 8 is a schematic diagram illustrating a specific example of the learning model creation processing. The training data set storage unit 470 of the information processing apparatus 1 stores a training data set 600 as illustrated in the drawing. The training data set 600 stores [the reflected light spectrum before the start of the plasma etching processing], [the selected intermediate reflected light spectrum], and [the reflected light spectrum after the end of the plasma etching processing] as input data. The training data set 600 stores [the etching depth before the start of the plasma etching processing], [the intermediate etching depth], and [the etching depth after the end of the plasma etching processing] as ground truth data. The input of the [reflected light spectrum before the start of the plasma etching processing] corresponds to the output of [the etching depth before the start of the plasma etching processing], the input of [the selected intermediate reflected light spectrum] corresponds to the output of [the intermediate etching depth], and the input of [the reflected light spectrum after the end of the plasma etching processing] corresponds to the output of [the etching depth after the end of the plasma etching processing].

The learning unit 440 includes the learning model 5 in which internal model parameters are set to appropriate initial values. The learning model is, for example, a learning model having a configuration such as a neural network or a support vector machine (SVM), and receives an input of a reflected light spectrum and outputs a predicted value of an etching depth. Further, the learning unit 440 includes a comparison and changing unit 602. The comparison and changing unit 602 compares output data output by the learning model 5 in response to an input of a reflected light spectrum with the ground truth data in the training data set 600 corresponding to the input reflected light spectrum, and updates the model parameters of the learning model 5 according to an error between the output data and the ground truth data. Accordingly, the learning unit 440 can perform so-called supervised machine learning using the training data set 600 to create the learning model 5.

### (3) Prediction Processing

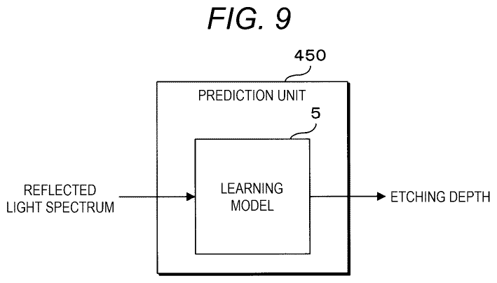

FIG. 9 is a schematic diagram illustrating a specific example of the prediction processing using the learning model 5. The prediction unit 450 of the information processing apparatus 1 includes the learning model 5 created by performing machine learning by the learning unit 440. The prediction unit 450 acquires reflected light spectra for a substrate to be monitored at a predetermined cycle from the spectroscopic device 115, and sequentially inputs the reflected light spectra into the learning model 5, thereby acquiring predicted values of etching depths corresponding to the respective reflected light spectra. The prediction unit 450 outputs the predicted values of the etching depths to the determination unit 460.

### <Flowchart>

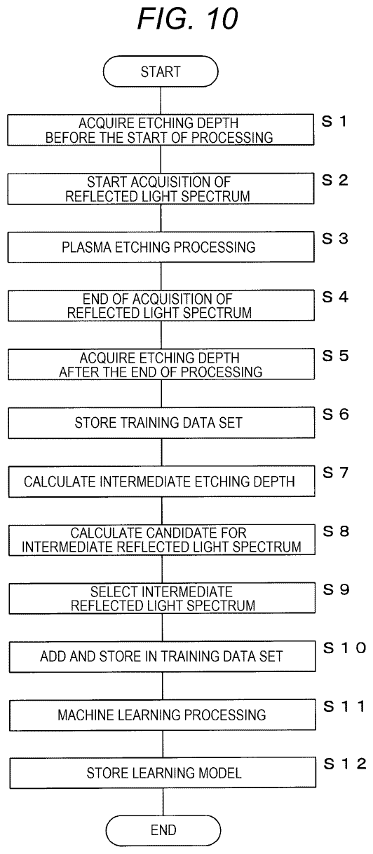

FIG. 10 is a flowchart illustrating an example of a processing procedure executed by the information processing apparatus 1 according to the present embodiment in the learning phase. First, the information processing apparatus 1 according to the present embodiment acquires a measurement value of an etching depth before the start of the plasma etching processing from the structure parameter measurement device 140 (step S1). Next, the information processing apparatus 1 starts acquisition of a reflected light spectrum measured by the spectroscopic device 115 of the substrate processing apparatus 100 (step S2). Thereafter, the information processing apparatus 1 causes the substrate processing apparatus 100 to execute the plasma etching processing (step S3), and continuous the acquisition of the reflected light spectrum during the plasma etching processing. After the plasma etching processing is completed, the information processing apparatus 1 ends the acquisition of the reflected light spectrum (step S4). Through steps S2 to S4, the information processing apparatus 1 can acquire reflected light spectra before the start of the plasma etching processing, during the plasma etching processing, and after the end of the plasma etching processing, and store the reflected light spectra in the training data set storage unit 470. Next, the information processing apparatus 1 acquires a measurement value of the etching depth after the end of the plasma etching processing from the structure parameter measurement device 140 (step S5). After the etching depth and the reflected light spectrum before the start of the plasma etching processing, the reflected light spectrum during the plasma etching processing, and the etching depth and the reflected light spectrum after the end of the plasma etching processing are received through steps S1 to S5, the information processing apparatus 1 stores these pieces of information as a training data set in the training data set storage unit 470 (step S6).

Next, the intermediate etching depth setting unit 410 of the information processing apparatus 1 calculates the intermediate etching depth based on the etching depth before the start of the plasma etching processing and the etching depth after the end of the plasma etching processing (step S7). The intermediate spectrum synthesis unit 420 of the information processing apparatus 1 executes the scale conversion processing and the translational movement processing on the reflected light spectrum before the start of the plasma etching processing and the reflected light spectrum after the end of the plasma etching processing, and calculates a candidate for the intermediate reflected light spectrum by calculating an average value when the similarity between the two reflected light spectra is maximized (step S8). The intermediate spectrum selecting unit 430 of the information processing apparatus 1 selects an intermediate reflected light spectrum by selecting a reflected light spectrum similar to the candidate for the intermediate reflected light spectrum calculated in step S8 from the plurality of reflected light spectra measured during the plasma etching processing (step S9). The intermediate spectrum selecting unit 430 adds and stores the selected intermediate reflected light spectrum to the training data set stored in step S6 (step S10).

After collecting a sufficient amount of the training data sets, the learning unit 440 of the information processing apparatus 1 uses a plurality of the training data sets stored in the training data set storage unit 470 to creates the learning model 5 by performing supervised machine learning (step S11) and determining model parameters of the learning model 5. The learning unit 440 stores information such as the model parameters related to the created learning model 5 (step S12), and ends the processing. Step S12 may also include a step of using the predicted value of the structure parameter to output a control signal that automatically adjusts an operational parameter of a substrate processing apparatus in real-time during the substrate processing.

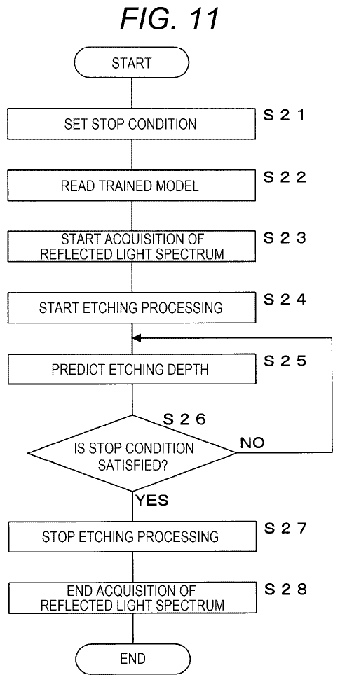

FIG. 11 is a flowchart illustrating an example of a processing procedure executed by the information processing apparatus 1 according to the present embodiment in the prediction phase. First, the determination unit 460 of the information processing apparatus 1 according to the present embodiment reads and sets a stop condition stored in advance from a memory or the like (step S21). The prediction unit 450 of the information processing apparatus 1 reads the created learning model 5 that has been trained through the machine learning (step S22).

The information processing apparatus 1 starts acquisition of a reflected light spectrum from the substrate processing apparatus 100 that executes the plasma etching processing on the substrate to be monitored (step S23). Thereafter, the information processing apparatus 1 causes the substrate processing apparatus 100 to start the plasma etching processing (step S24). Thereafter, the information processing apparatus 1 continuously acquires a measurement result of the reflected light spectrum during the plasma etching processing.

The prediction unit 450 of the information processing apparatus 1 inputs the reflected light spectrum acquired from the substrate processing apparatus 100 into the learning model 5, and predicts an etching depth for the reflected light spectrum by acquiring a predicted value of an etching depth output by the learning model 5 (step S25). The determination unit 460 of the information processing apparatus 1 determines whether the etching depth predicted in step S25 satisfies the stop condition set in step S21 (step S26). When the stop condition is not satisfied (S26: NO), the determination unit 460 returns the processing to step S25. When the stop condition is satisfied (step S26: YES), the determination unit 460 stops the plasma etching processing of the substrate processing apparatus 100 (step S27). Next, the information processing apparatus 1 ends the acquisition of the reflected light spectrum from the substrate processing apparatus 100 (step S28), and ends the processing.

### <Summary>

In the information processing system according to the present embodiment configured as described above, the information processing apparatus 1 acquires structure parameters (etching depths) and reflected light spectra before and after a change in a state of a substrate caused by the substrate processing (the plasma etching processing) for changing the state of the substrate, calculates a structure parameter and a reflected light spectrum at a predetermined timing in a change period based on the acquired structure parameters and reflected light spectra before and after the change, and creates the learning model 5 that receives a reflected light spectrum as an input and outputs a predicted value of a structure parameter, by performing machine learning using a training data set that includes the structure parameters and reflected light spectra before and after the change, and the calculated structure parameter and reflected light spectrum at the predetermined timing.

In the information processing system according to the present embodiment, the information processing apparatus 1 acquires a reflected light spectrum of a substrate to be monitored from the substrate processing apparatus 100, inputs the acquired reflected light spectrum into the learning model 5 created in advance through machine learning, and acquires a predicted value of a structure parameter output from the learning model 5, thereby predicting a structure parameter at a timing when the reflected light spectrum of the target substrate is measured.

Accordingly, the information processing system according to the present embodiment can collect a sufficient amount of the training data sets to perform machine learning for the learning model 5, and can be expected to create the learning model 5 with high prediction accuracy. Therefore, the information processing system can be expected to predict a structure parameter (e.g., an etching depth) at any timing in the substrate processing (e.g., the plasma etching processing).

### Embodiment 2

A case of predicting an etching depth as the structure parameter is described in Embodiment 1 described above. Alternatively, the structure parameter that can be predicted at any timing is not limited to the etching depth, and may be, for example, a mask CD. Therefore, a case where the mask CD is predicted as the structure parameter will be described in Embodiment 2. Hereinafter, differences from Embodiment 1 will be mainly described.

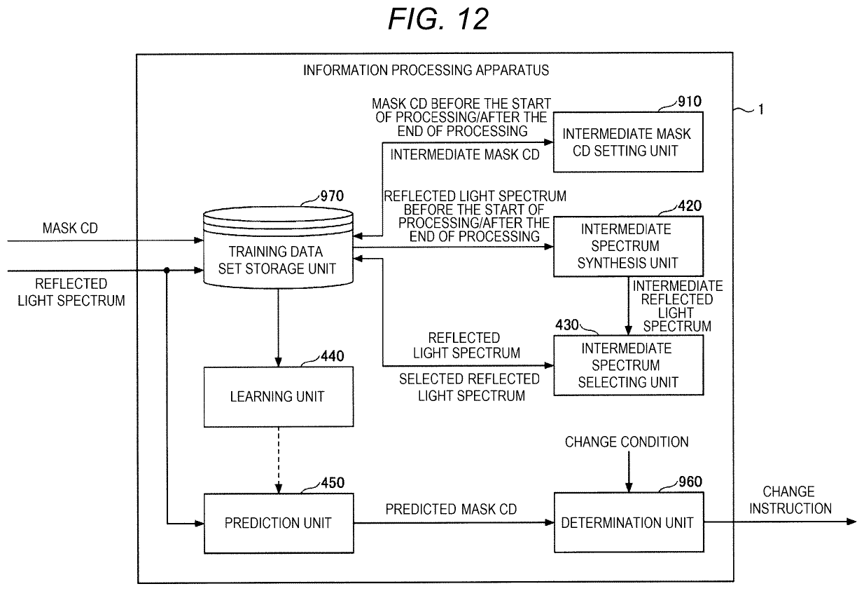

FIG. 12 is a block diagram illustrating an example of a functional configuration of the information processing apparatus 1 according to Embodiment 2. In the learning phase, the information processing apparatus 1 according to Embodiment 2 functions as functional units such as an intermediate mask CD setting unit 910, an intermediate spectrum synthesis unit 420, an intermediate spectrum selecting unit 430, and a learning unit 440. To operate the above-described functional units in the learning phase, a training data set storage unit 970 according to Embodiment 2 stores reflected light spectra measured by the spectroscopic device 115 in a measurement period from before the start of the plasma etching processing (substrate processing) to after the end of the plasma etching processing. The training data set storage unit 970 stores, as a training data set, mask CDs measured by the structure parameter measurement device 140 before the start of the plasma etching processing and after the end of the plasma etching processing and reflected light spectra measured by the spectroscopic device 115 before the start of the plasma etching processing and after the end of the plasma etching processing in association with each other.

The intermediate mask CD setting unit 910 reads the mask CD before the start of the plasma etching processing and the mask CD after the end of the plasma etching processing, which are stored in the training data set storage unit 970. The intermediate mask CD setting unit 910 calculates an intermediate mask CD between the mask CD before the start of the plasma etching processing and the mask CD after the end of the plasma etching processing. For example, when the mask CD before the start of the plasma etching processing is defined as [CDmask-in] and the mask CD after the end of the plasma etching processing is defined as [CDmask-out], the intermediate mask CD setting unit 910 calculates the intermediate mask CD by the following calculation formula. The intermediate mask CD setting unit 910 stores the calculated intermediate mask CD in the training data set as ground truth data for an intermediate reflected light spectrum.

$$Intermedite mask CD = ( CDmask - in + CDmask - out ) / 2$$

The intermediate spectrum synthesis unit 420, the intermediate spectrum selecting unit 430, and the learning unit 440 in FIG. 12 are similar to the intermediate spectrum synthesis unit 420, the intermediate spectrum selecting unit 430, and the learning unit 440 described with reference to FIG. 6 in Embodiment 1, and thus descriptions thereof will be omitted.

On the other hand, the information processing apparatus 1 according to Embodiment 2 functions as functional units such as the prediction unit 450 and a determination unit 960 in the prediction phase. Functions of the prediction unit 450 is the same as those of the prediction unit 450 described with reference to FIG. 6 in Embodiment 1, and thus descriptions thereof will be omitted. However, the prediction unit 450 illustrated in FIG. 12 predicts mask CDs for a substrate to be monitored by inputting the reflected light spectrum at a predetermined cycle, and sequentially inputs the predicted mask CDs into the determination unit 960.

Based on the mask CDs predicted by the prediction unit 450, the determination unit 960 determines whether a change condition for changing a recipe of the plasma etching processing is satisfied. A change condition for changing a recipe of the plasma etching processing is set in advance in the information processing apparatus 1, and the determination unit 960 determines whether the change condition is satisfied. The change condition includes a detection timing and a determination item. For example, the determination timing is set to “at the start of the plasma processing and immediately after the start of the plasma processing,” and the determination item is set to “outside an allowable range of a mask CD”. When it is determined that the change condition is satisfied (for example, when the mask CD input by the prediction unit 450 exceeds the allowable value and falls outside the allowable range), the determination unit 460 outputs an alarm and outputs a change instruction to change a recipe of the plasma etching processing to the control device 130 of the substrate processing apparatus 100. Accordingly, the control device 130 can change a recipe in real time during the plasma etching processing.

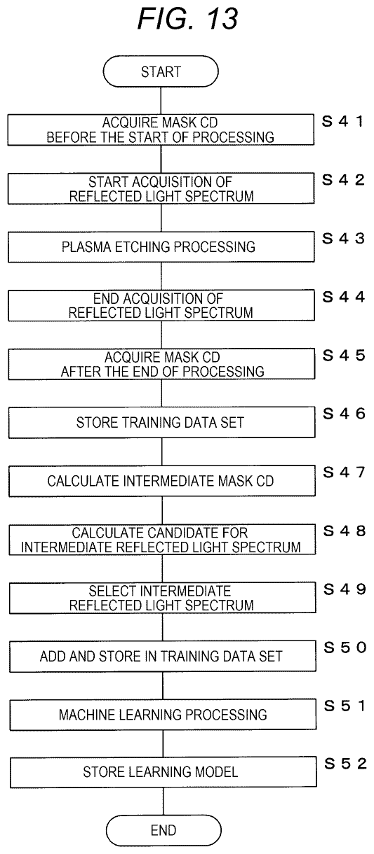

FIG. 13 is a flowchart illustrating an example of a processing procedure executed by the information processing apparatus 1 according to Embodiment 2 in the learning phase. First, the information processing apparatus 1 according to Embodiment 2 acquires a measurement value of the mask CD before the start of the plasma etching processing from the structure parameter measurement device 140 (step S41). Next, the information processing apparatus 1 starts acquisition of a reflected light spectrum measured by the spectroscopic device 115 of the substrate processing apparatus 100 (step S42). Thereafter, the information processing apparatus 1 causes the substrate processing apparatus 100 to execute the plasma etching processing (step S43), and continues the acquisition of the reflected light spectrum during the plasma etching processing. After the plasma etching processing is completed, the information processing apparatus 1 ends the acquisition of the reflected light spectrum (step S44). Through steps S42 to S44, the information processing apparatus 1 can acquire reflected light spectra before the start of the plasma etching processing, during the plasma etching processing, and after the end of the plasma etching processing, and store the reflected light spectra in the training data set storage unit 970. Next, the information processing apparatus 1 acquires a measurement value of the mask CD after the end of the plasma etching processing from the structure parameter measurement device 140 (step S45). After the mask CD and the reflected light spectrum before the start of the plasma etching processing, the reflected light spectrum during the plasma etching processing, and the mask CD and the reflected light spectrum after the end of the plasma etching processing are received through steps S41 to S45, the information processing apparatus 1 stores these pieces of information as a training data set in the training data set storage unit 970 (step S46).

Next, the intermediate mask CD setting unit 910 of the information processing apparatus 1 calculates the intermediate mask CD based on the mask CD before the start of the plasma etching processing and the mask CD after the end of the plasma etching processing (step S47). The intermediate spectrum synthesis unit 420 of the information processing apparatus 1 executes the scale conversion processing and the translational movement processing on the reflected light spectrum before the start of the plasma etching processing and the reflected light spectrum after the end of the plasma etching processing, and calculates a candidate for an intermediate reflected light spectrum by calculating an average value when the similarity between the two reflected light spectra is maximized (step S48). The intermediate spectrum selecting unit 430 of the information processing apparatus 1 selects an intermediate reflected light spectrum by selecting a reflected light spectrum similar to the candidate of the intermediate reflected light spectrum calculated in step S48 from the plurality of reflected light spectra measured during the plasma etching processing (step S49). The intermediate spectrum selecting unit 430 adds and stores the selected intermediate reflected light spectrum to the training data set stored in step S46 (step S50).

After collecting a sufficient amount of the training data sets, the learning unit 440 of the information processing apparatus 1 uses a plurality of the training data sets stored in the training data set storage unit 470 to perform supervised machine learning (step S51), and creates the learning model 5 by determining model parameters of the learning model 5. The learning unit 440 stores information such as the model parameters related to the created learning model 5 (step S52), and ends the processing.

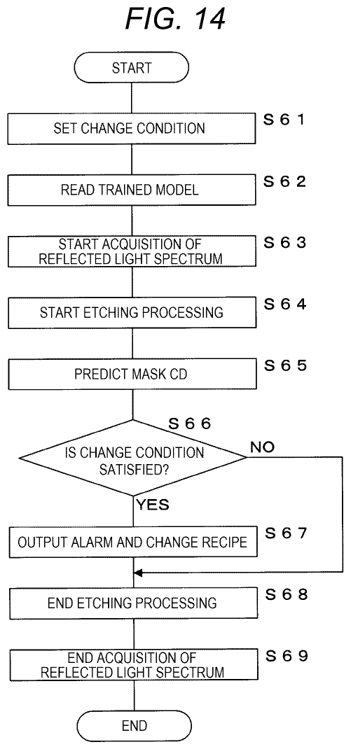

FIG. 14 is a flowchart illustrating an example of a processing procedure executed by the information processing apparatus 1 according to Embodiment 2 in the prediction phase. First, the determination unit 460 of the information processing apparatus 1 according to Embodiment 2 reads and sets a change condition stored in advance from a memory or the like (step S61). The prediction unit 450 of the information processing apparatus 1 reads the created learning model 5 that has been trained through the machine learning (step S62). The information processing apparatus 1 starts acquisition of a reflected light spectrum from the substrate processing apparatus 100 that executes the plasma etching processing on the substrate to be monitored (step S63). Thereafter, the information processing apparatus 1 causes the substrate processing apparatus 100 to start the plasma etching processing (step S64). Thereafter, the information processing apparatus 1 continuously acquires a measurement result of the reflected light spectrum during the plasma etching processing.

The prediction unit 450 of the information processing apparatus 1 inputs the reflected light spectrum acquired from the substrate processing apparatus 100 into the learning model 5, and predicts a mask CD for the reflected light spectrum by acquiring a predicted value of a mask CD output by the learning model 5 (step S65). The determination unit 460 of the information processing apparatus 1 determines whether the mask CD predicted in step S65 satisfies the change condition set in step S61 (step S66). Specifically, the information processing apparatus 1 determines whether the mask CD predicted based on the reflected light spectrum measured at the start of the plasma etching processing and immediately after the start of the plasma etching processing exceeds an allowable value and falls outside the allowable range.

When the change condition is satisfied (step S66: YES), the determination unit 460 outputs an alarm, changes a recipe related to the plasma etching processing executed by the substrate processing apparatus 100 (step S67), and proceeds the processing to step S68. Thereafter, the substrate processing apparatus 100 executes the plasma etching processing on the substrate 160 based on the changed recipe. When the change condition is not satisfied (S26: NO), the determination unit 460 proceeds the processing to step S68 without changing the recipe. After the plasma etching processing on the target substrate is completed, the information processing apparatus 1 stops the plasma etching processing in the substrate processing apparatus 100 (step S68). Next, the information processing apparatus 1 ends the acquisition of the reflected light spectrum from the substrate processing apparatus 100 (step S69), and ends the processing.

In the information processing system according to Embodiment 2 configured as described above, the information processing apparatus 1 acquires mask CDs and reflected light spectra before and after a change in a state of the substrate caused by the plasma etching processing for changing the state of the substrate, calculates a mask CD and a reflected light spectrum at a predetermined timing in a change period based on the acquired mask CDs and reflected light spectra before and after the change, and creates the learning model 5 that receives a reflected light spectrum as an input and outputs a predicted value of a mask CD, by performing machine learning using a training data set that includes the mask CDs and the reflected light spectra before and after the change, and the calculated mask CD and reflected light spectrum at the predetermined timing.

In the information processing system according to Embodiment 2, the information processing apparatus 1 acquires a reflected light spectrum of a substrate to be monitored from the substrate processing apparatus 100, inputs the acquired reflected light spectrum into the learning model 5 created in advance through machine learning, and acquires a predicted value of a mask CD output from the learning model 5, thereby predicting a mask CD at a timing when the reflected light spectrum of the target substrate is measured.

Accordingly, the information processing system according to Embodiment 2 can collect a sufficient amount of the training data sets to perform machine learning for the learning model 5, and can be expected to create the learning model 5 with high prediction accuracy. Therefore, the information processing system can be expected to predict a mask CD at any timing in the plasma etching processing.

### Other Embodiments

Although case where an etching depth or a mask CD is predicted as a structure parameter is described in Embodiment 1 or Embodiment 2 described above, the structure parameter to be predicted is not limited thereto, and the learning model 5 may predict a structure parameter other than the etching depth or the mask CD.

A case where an intermediate structure parameter is calculated to collect a sufficient amount of training data sets is described in Embodiment 1 or Embodiment 2 described above. However, a structure parameter to be newly calculated is not limited to the intermediate structure parameter, and the information processing apparatus 1 may calculate a structure parameter at a predetermined timing other than the intermediate structure parameter as a training data set. Specifically, a structure parameter and a reflected light spectrum at a timing when, for example, reaching a ¼×change amount among change amounts in a change period between a state of the substrate before the start of the plasma etching processing and a state of the substrate after the end of the plasma etching processing, may be calculated. Alternatively, a structure parameter and a reflected light spectrum at a timing when, for example, reaching a ¾×change amount among change amounts in a change period between a state of the substrate before the start of the plasma etching processing and a state of the substrate after the end of the plasma etching processing, may be calculated. In other words, the structure parameter and the reflected light spectrum at any timing in the change period may be calculated to create a training data set.

A case where a training data set is created based on a structure parameter and a reflected light spectrum before the start of the plasma etching processing and a structure parameter and a reflected light spectrum after the end of the plasma etching processing is described in Embodiment 1 or Embodiment 2 described above. However, a method of creating the training data set is not limited thereto, and the training data set may be created based on structure parameters and reflected light spectra before and after a change when a state of the substrate changes.

Here, before and after the change when the state of the substrate changes include, for example, [immediately before and immediately after the end of the substrate processing], or [before and after a change point of a multilayer layer in the substrate processing]. In any case, it is assumed that the structure parameter and the reflected light spectrum before the change when the state of the substrate changes and the structure parameter and the reflected light spectrum after the change when the state of the substrate changes are measured. In this case, the structure parameter and the reflected light spectrum at any timing in the change period are calculated to create the training data set, and the prediction unit 450 predicts a structure parameter based on a reflected light spectrum measured during the substrate processing.

A case where a structure parameter predicted by the prediction unit 450 is used for stopping the plasma etching processing and changing a recipe is described in Embodiment 1 or Embodiment 2 described above. However, a method of using the structure parameter predicted by the prediction unit 450 is not limited thereto, and the information processing apparatus 1 may use the predicted structure parameter for another control processing. In this case, the determination unit sets a condition (detection timing, determination item) in response to the control processing in which the predicted structure parameter is to be used.

Embodiment 1 or Embodiment 2 described above does not mention a calculation method for the intermediate spectrum selecting unit 430 to calculate the correlation or the error with the intermediate reflected light spectrum candidate. However, the method of calculating the correlation or the error can be freely selected. For example, a correlation coefficient such as Pearson, Spearman, or Kendall may be used in the calculation of the correlation. An index value such as a mean squared error (MSE) or a mean absolute error (MAE) may be used in the calculation of the error.

A case where the information processing apparatus 1 executes processing using a reflected light spectrum measured by the spectroscopic device 115 is described in Embodiment 1 or Embodiment 2 described above. However, the information processing apparatus 1 may execute processing after a process on the reflected light spectrum measured by the spectroscopic device 115. The process referred to herein includes, for example, normalizing the reflected light spectrum, calculating a difference from a reference reflected light spectrum, making a light intensity of a specific wavelength zero, and converting a reflected light spectrum into a feature value.

Embodiment 1 or Embodiment 2 described above does not mention a specific example of the learning model 5. However, the learning model 5 may be, for example, a model operating according to a machine learning algorithm such as principal component regression, partial least squares regression, neural network, support vector machine, random forest regression, or gradient boosting regression.

The information processing system has the system configuration illustrated in FIG. 1 in Embodiment 1 or Embodiment 2 described above. However, the system configuration of the information processing system is not limited thereto. For example, the substrate processing apparatus 100 and the information processing apparatus 1 do not need to be separate apparatuses. The information processing apparatus 1 may be implemented as a part of the function of the substrate processing apparatus 100 that includes the spectral reflectometer 110, the plasma processing chamber 120, the control device 130, and the like. In this case, each functional unit of the information processing apparatus 1 may be implemented by the control device 130.

The information processing apparatus 1 is applied to the substrate processing apparatus 100 that executes the plasma etching processing in Embodiment 1 or Embodiment 2 described above. However, an apparatus to which the information processing apparatus 1 is applied is not limited to the substrate processing apparatus 100 that executes the plasma etching processing, and may be a substrate processing apparatus that executes substrate processing other than the plasma etching processing. The substrate processing apparatus that executes substrate processing other than the plasma etching processing may be, for example, a substrate processing apparatus that executes film formation processing, chemical mechanical polishing (CMP) processing, or the like. In a case where the information processing apparatus 1 is applied to a substrate processing apparatus that executes film formation processing, for example, a film thickness is predicted as a structure parameter. The film thickness referred to herein may be a film thickness of a monolayer film or a film thickness of a multilayer film. Further, the film thickness may be a film thickness when a film is formed on a substrate (film thickness of a solid film) or a film thickness when a film is formed on a pattern structure.

Further, the substrate processed by the substrate processing apparatus 100 may have any structure (pattern). For example, the substrate may have a structure in which a hole is formed in an insulating film, a structure in which a groove (trench) is formed, a structure in which a hole and a groove are formed in a mixed manner, or the like.

The embodiments disclosed herein are exemplary in all respects and can be considered to be not restrictive. The scope of the present disclosure is indicated by the claims, not the above-described meaning, and is intended to include all modifications within the meaning and scope equivalent to the claims.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

1. A method comprising:
by an information processing apparatus,
acquiring structure parameters and reflected light spectra before and after a change in a state of a substrate caused by substrate processing for changing the state of the substrate;
calculating a structure parameter and a reflected light spectrum at a predetermined timing in a change period based on the acquired structure parameters and reflected light spectra before and after the changing the state of the substrate;
creating a learning model that receives a reflected light spectrum as an input and outputs a predicted value of a structure parameter, by performing machine learning using a training data set that includes the structure parameters and the reflected light spectra before and after changing the state of the substrate and the calculated structure parameter and reflected light spectrum at the predetermined timing; and
using the predicted value of the structure parameter to output a control signal that automatically adjusts an operational parameter of a substrate processing apparatus in real-time during the substrate processing.

2. The method according to claim 1, wherein
the structure parameter at the predetermined timing is calculated based on the structure parameters before and after changing the state of the substrate.

3. The method according to claim 1, further comprising:
calculating a candidate for the reflected light spectrum at the predetermined timing based on the reflected light spectra before and after changing the state of the substrate; and
calculating the reflected light spectrum at the predetermined timing by selecting a reflected light spectrum similar to the calculated candidate from a plurality of reflected light spectra measured in advance in relation to the substrate processing.

4. The method according to claim 3, wherein
the candidate is calculated by performing scale conversion or translational movement on the reflected light spectra before and after changing the state of the substrate in either one or both of a wavelength axis direction or a light intensity axis direction.

5. The method according to claim 3, wherein
the reflected light spectrum similar to the candidate is selected from the plurality of reflected light spectra by calculating a correlation or an error between the plurality of reflected light spectra and the reflected light spectrum at the predetermined timing.

6. The method according to claim 1, wherein
before and after changing the state of the substrate include any one of before the start of the substrate processing and after the end of the substrate processing, immediately before and immediately after the end of the substrate processing, or before and after a change point of a multilayer layer in the substrate processing.

7. The method according to claim 1, wherein the operational parameter including at least one of plasma power level, gas flow rate, or chamber pressure.

8. An information processing method comprising:
by an information processing apparatus,
acquiring a reflected light spectrum of a target substrate;
inputting the acquired reflected light spectrum of the target substrate into a learning model that receives a reflected light spectrum as an input and outputs a predicted value of a structure parameter and that is created by machine learning using a training data set, the training data set including structure parameters and reflected light spectra before and after a change in a state of the substrate caused by substrate processing for changing the state of the substrate, and a structure parameter and a reflected light spectrum at a predetermined timing in a change period which are calculated based on the structure parameters and the reflected light spectra before and after changing the state of the substrate;
predicting a structure parameter at a timing when a reflected light spectrum of the target substrate is measured, by acquiring the predicted value of the structure parameter output by the learning model; and
using the predicted the structure parameter to output a control signal that automatically adjusts an operational parameter of a substrate processing apparatus in real-time during substrate processing.

9. The information processing method according to claim 8, further comprising:
determining whether the predicted structure parameter of the target substrate satisfies a stop condition for stopping the substrate processing; and
stopping the substrate processing on the target substrate when it is determined that the stop condition is satisfied.

10. The information processing method according to claim 8, further comprising:
determining whether the predicted structure parameter of the target substrate satisfies a change condition for changing the substrate processing; and
changing the substrate processing on the target substrate when it is determined that changing the state of the substrate condition is satisfied.

11. A non-transitory computer-readable storage medium having computer-executable instructions stored thereon, which when executed by a processor, cause the processor to perform a method comprising:
acquiring structure parameters and reflected light spectra before and after a change in a state of a substrate caused by substrate processing for changing the state of the substrate;
calculating a structure parameter and a reflected light spectrum at a predetermined timing in a change period based on the acquired structure parameters and reflected light spectra before and after changing the state of the substrate;
creating a learning model that receives a reflected light spectrum as an input and outputs a predicted value of a structure parameter, by performing machine learning using a training data set that includes the structure parameters and the reflected light spectra before and after changing the state of the substrate and the calculated structure parameter and reflected light spectrum at the predetermined timing; and
using the predicted value of the structure parameter to output a control signal that automatically adjusts an operational parameter of a substrate processing apparatus in real-time during the substrate processing.

12. A non-transitory computer-readable storage medium having computer-executable instructions stored thereon, which when executed by a processor, cause the processor to perform a method comprising: acquiring a reflected light spectrum of a target substrate;
inputting the acquired reflected light spectrum of the target substrate into a learning model that receives a reflected light spectrum as an input and outputs a predicted value of a structure parameter and that is created by machine learning using a training data set, the training data set including structure parameters and reflected light spectra before and after a change in a state of the substrate caused by substrate processing for changing the state of the substrate, and a structure parameter and a reflected light spectrum at a predetermined timing in a change period which are calculated based on the structure parameters and the reflected light spectra before and after changing the state of the substrate;
predicting a structure parameter at a timing when a reflected light spectrum of the target substrate is measured, by acquiring the predicted value of the structure parameter output by the learning model; and
using the predicted value of the structure parameter to output a control signal that automatically adjusts an operational parameter of a substrate processing apparatus in real-time during the substrate processing.

13. The non-transitory computer-readable storage medium according to claim 12, wherein the method further comprises:
determining whether the predicted structure parameter of the target substrate satisfies a stop condition for stopping the substrate processing; and
stopping the substrate processing on the target substrate when it is determined that the stop condition is satisfied.

14. The non-transitory computer-readable storage medium according to claim 12, wherein the method further comprises:
determining whether the predicted structure parameter of the target substrate satisfies a change condition for changing the substrate processing; and
changing the substrate processing on the target substrate when it is determined that changing the state of the substrate condition is satisfied.

15. An information processing apparatus comprising:
circuitry configured to:
acquire structure parameters and reflected light spectra before and after a change in a state of a substrate caused by substrate processing for changing the state of the substrate,
calculate a structure parameter and a reflected light spectrum at a predetermined timing in a change period based on the acquired structure parameters and reflected light spectra before and after changing the state of the substrate,
create a learning model that receives a reflected light spectrum as an input and outputs a predicted value of a structure parameter, by performing machine learning using a training data set that includes the structure parameters and the reflected light spectra before and after changing the state of the substrate and the calculated structure parameter and reflected light spectrum at the predetermined timing, and
using the predicted the structure parameter to output a control signal that automatically adjusts an operational parameter of a substrate processing apparatus in real-time during substrate processing.

16. The information processing apparatus according to claim 15, wherein the circuitry is further configured to:
calculating a candidate for the reflected light spectrum at the predetermined timing based on the reflected light spectra before and after changing the state of the substrate; and
calculating the reflected light spectrum at the predetermined timing by selecting a reflected light spectrum similar to the calculated candidate from a plurality of reflected light spectra measured in advance in relation to the substrate processing.

17. The information processing apparatus according to claim 16, wherein
the candidate is calculated by performing scale conversion or translational movement on the reflected light spectra before and after changing the state of the substrate in either one or both of a wavelength axis direction or a light intensity axis direction.

18. The information processing apparatus according to claim 16, wherein
the reflected light spectrum similar to the candidate is selected from the plurality of reflected light spectra by calculating a correlation or an error between the plurality of reflected light spectra and the reflected light spectrum at the predetermined timing.

19. An information processing apparatus comprising:
circuitry configured to:
acquire a reflected light spectrum of a target substrate,
input the acquired reflected light spectrum of the target substrate into a learning model that receives a reflected light spectrum as an input and outputs a predicted value of a structure parameter and that is created by machine learning using a training data set, the training data set including structure parameters and reflected light spectra before and after a change in a state of the substrate caused by substrate processing for changing the state of the substrate, and a structure parameter and a reflected light spectrum at a predetermined timing in a change period which are calculated based on the structure parameters and the reflected light spectra before and after changing the state of the substrate,
predict a structure parameter at a timing when a reflected light spectrum of the target substrate is measured, by acquiring the predicted value of the structure parameter output by the learning model, and
using the predicted the structure parameter to output a control signal that automatically adjusts an operational parameter of a substrate processing apparatus in real-time during substrate processing.

20. The information processing apparatus according to claim 19, wherein the circuitry is further configured to:
determine whether the predicted structure parameter of the target substrate satisfies a stop condition for stopping the substrate processing; and
stop the substrate processing on the target substrate when it is determined that the stop condition is satisfied.
